(19) United States
(12) Patent Application Publication
(10) Pub. No.: US 2016/0214190 A1
(43) Pub. Date: Jul. 28, 2016

(54) CHANNEL SAMPLE SAW AND SPACER

(71) Applicant: Dave PYKARI, Murillo (CA)

(72) Inventor: Dave PYKARI, Murillo (CA)

(21) Appl. No.: 15/021,086

(22) PCT Filed: Sep. 10, 2014
(86) PCT No.: PCT/CA2014/000674

§ 371 Date: Mar. 10, 2016

Related U.S. Application Data
(60) Provisional application No. 61/875,825, filed on Sep. 10, 2013.

(51) Int. Cl. B23D 61/10; B23D 45/10; B28D 1/04; B23D 59/00

(52) U.S. Cl. CPC B23D 61/10; B23D 59/00; B23D 45/10; B28D 1/048

(57) ABSTRACT

A spacer for attaching a first rotary blade and a second rotary blade to a rotary blade saw comprises a main block having a first side and a second side, the first side and the second side being parallel and the main block having with a bore through the center of the block in a direction perpendicular to the first side and the second side, the bore being a center point of the first side and the second side. There is a first protrusion extending from around the bore on the first side, perpendicular to the first side, the protrusion sized to fit into a center hole on a the first rotary blade. A second protrusion extends from around the bore on the second side, perpendicular to the second side, the second protrusion sized to fit into a center hole on the second rotary blade.

### TECHNICAL FIELD

The present disclosure relates to a spacer for a dual blade channel sample saw, a dual blade channel sample saw and a method of modifying a single rotary blade saw to add an additional rotary blade.

### BACKGROUND

In the mining industry, channel samples are often cut from rock in area to determine the makeup of the rock. The samples are usually cut by using a rotary saw, such as the TS 500i by Stihl™. Two parallel cuts approximately 1.5 inches apart and 4 inches deep are cut into the rock in order to extract a sample. To make the cuts, one is made first and then, the second cut is made parallel to the first. Maintaining a constant sample width between the cuts is critical but difficult when two separate cuts are made. Usually the samples are one foot long or longer.

### SUMMARY

In one aspect, there is provided a spacer for attaching a first rotary blade and a second rotary blade to a rotary blade saw, the spacer comprising: a main block having a first side and a second side, the first side and the second side being parallel and the main block having with a bore through the center of the block in a direction perpendicular to the first side and the second side, the bore being a center point of the first side and the second side; and a first protrusion extending from around the bore on the first side, perpendicular to the first side, the protrusion sized to fit into a center hole on a the first rotary blade; and a second protrusion extending from around the bore on the second side, perpendicular to the second side, the second protrusion sized to fit into a center hole on the second rotary blade. In some embodiments, the main block further comprises a recessed portion around the bore on each of the parallel sides, the recessed portion being of the same shape as the parallel sides, and the protrusions being in the recessed portion.

In another aspect, there is provided a spacer assembly kit comprising: the spacer described herein and a bolt of a length longer than a width of the spacer between the two parallel sides, the width of the first rotary blade, the width of the second rotary blade, a cone shaped washer and a flat washer.

In another aspect, there is provided a saw comprising: a motor; a drive shaft; two rotary blades; the spacer assembly kit described herein.

### BRIEF DESCRIPTION OF THE DRAWINGS

FIG. 1 is a drawing of a front view of an example spacer according to the present disclosure;

FIG. 2 is a drawing of a first side view of an example spacer according to the present disclosure;

FIG. 3 is a drawing of a second side view of an example spacer according to the present disclosure;

FIGS. 4A to 4C are line drawings of a first side view, a front view and a second side view of an example spacer according to the present disclosure;

FIG. 5 is a drawing demonstrating assembling an example spacer according to the present disclosure with a rotary blade;

FIG. 6 is a drawing showing the components required to assemble a dual blade rotary saw using an example spacer according to the present disclosure;

FIG. 7 is a drawing showing a dual blade rotary saw comprising an example spacer according to the present disclosure;

FIG. 8 is a line drawing of an example spacer according to the present disclosure; and

FIG. 9 is a line drawing of an example spacer according to the present disclosure.

### DETAILED DESCRIPTION

A spacer is disclosed that can be used to modify a rotary saw to attach a second rotary blade in a manner that enables the saw to be used to cut two parallel cuts concurrently. When used for extracting or cutting a channel sample, this modification makes it easier to ensure that the sample is a constant width. It also speeds up the process of obtaining the sample, as only one pass with the saw is required.

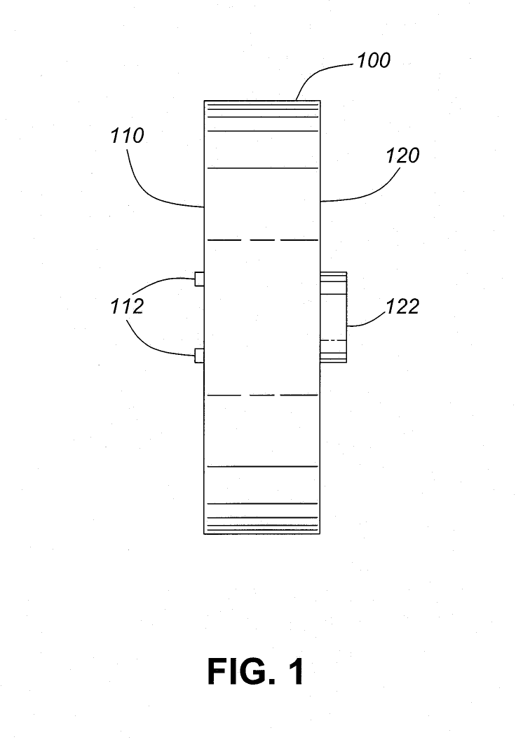

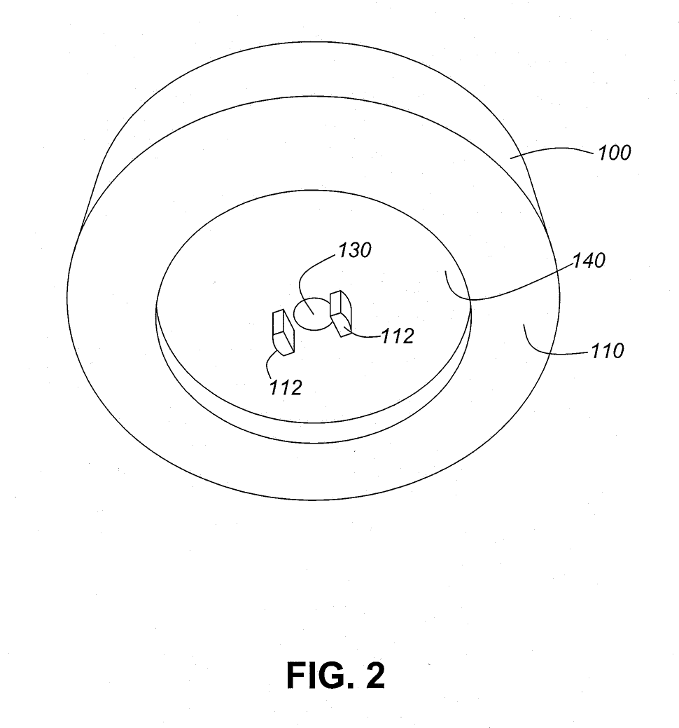

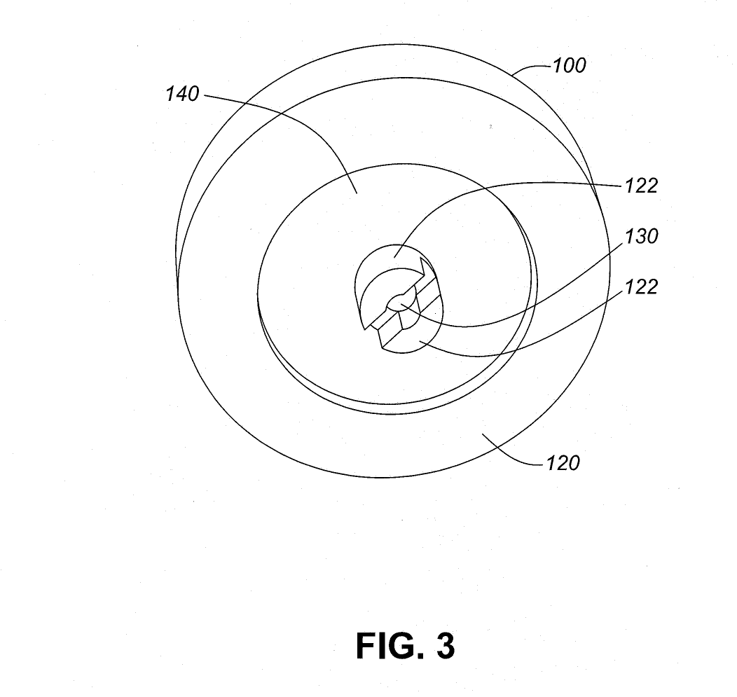

Referring to FIGS. 1 to 3, one embodiment of a spacer 100 for attaching a first rotary blade and a second rotary blade to a rotary blade saw will be described. The spacer comprises a main block having a first side 110 and a second side 120, the first side and the second side being parallel and the main block having a bore 130 through the center of the block in a direction perpendicular to the first side and the second side, the bore being a center point of the first side and the second side; and a first protrusion 112 extending from around the bore on the first side, perpendicular to the first side, the first protrusion sized to fit into a center hole on a the first rotary blade; and a second protrusion 122 extending from around the bore on the second side, perpendicular to the second side, the second protrusion sized to fit into a center hole on the second rotary blade. Although not required in all embodiments, the embodiments shown also include a recess 140 on each side around the bore 130.

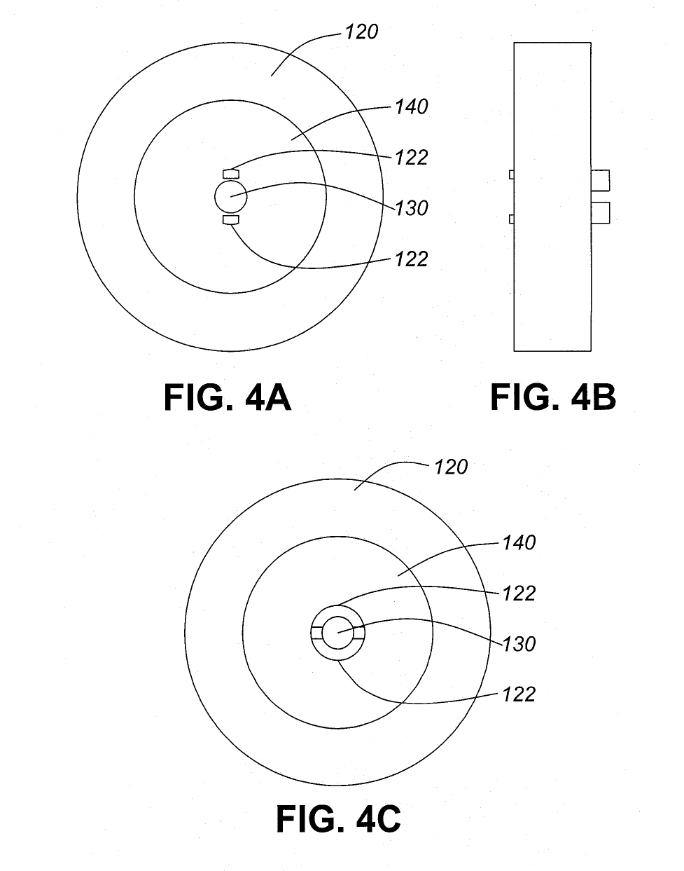

An example embodiment of the spacer 100 is shown in FIGS. 4A to 4C. This spacer is designed to be used on a TS 500i Stihl saw. In the example embodiment, the spacer is cylindrical in shape. Other shapes are feasible, such as but not limited to polygonal prism. The more sides or the closer to round the parallel sides are, the better for ensuring the spacer is balanced when rotating in use. In one embodiment, the main block is 1.000″ wide with the parallel sides 110 and 120 having a diameter of 3.935″. The bore 130 through the center has a 0.390 diameter. The first protrusion 112 comprises two arcs (the circle formed by the arcs having an inner diameter of 0.490″ and an outer diameter of 0.720″), each arc having a length of 0.225″ and extending 0.049″ past the out surface of the first side of the main block. The second protrusion 122 is circular in shape, having an inner diameter of 0.254″ (thus covering a portion of the bore) and an outer diameter of 0.785″ and a length extending past the outer surface of the second side by 0.248″. In some embodiments the second protrusion 122 comprises two arcs. In some embodiments, the two arcs of the second protrusion are significantly larger that the arcs of the first protrusion. In other embodiments, the main block is 1.250″ wide and 1.500″ wide. It is to be understood that any width that can be accommodated by the saw to be modified is possible. The width used will depend on the channel sample width desired.

In some embodiments, the main block further comprises a recessed portion 140 around the bore 130 on each of the parallel sides 110 and 120, the recessed portions 140 being of the same shape as the parallel sides, and the protrusions 112 and 122 being in the recessed portion. In example embodiments, the recessed portions 140 have been sized to allow protrusions of sufficient length to extend through the saw blades. In determining the size of the recessed portions, consideration should be given to transmitting enough torque evenly. In one example embodiment, the recessed portion on the first side has a diameter of 1.50″ and a depth of 0.306″ and the recessed portion on the second side has a diameter of 1.50″ and a depth of 0.493″. The recessed portions accommodate the cone shaped washer used on the TS 500i saw and assists in preventing slippage. Additionally, the recessed portions reduce weight and prevent debris from eroding the spacer to blade contact area which would in turn reduce the ability to transmit torque between the space and blades, resulting in blade slippage.

In some embodiments, the first protrusion has a length sufficient to extend through the first rotary blade when the first rotary blade is flush with the first side.

In some embodiments, the second protrusion has a length sufficient to extend through the second rotary blade and a washer.

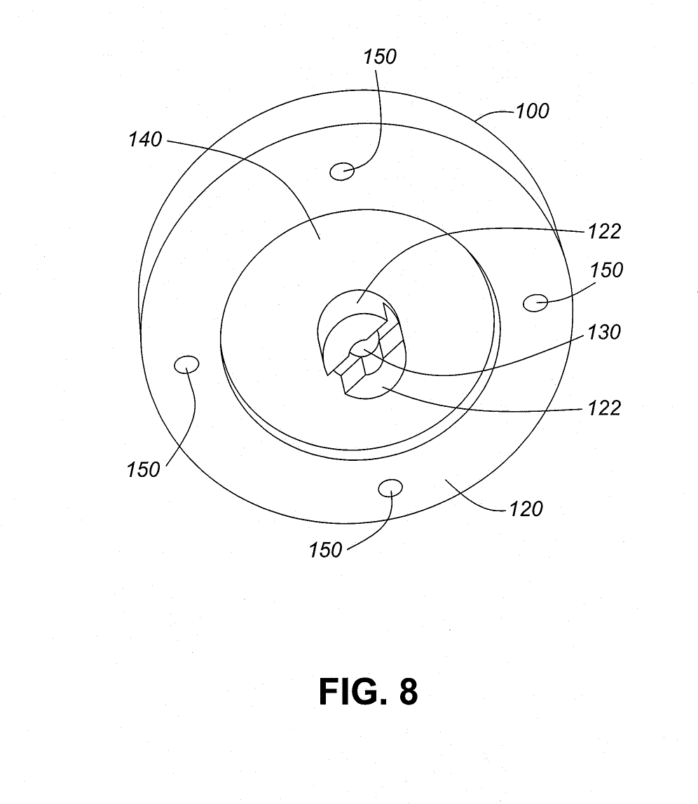

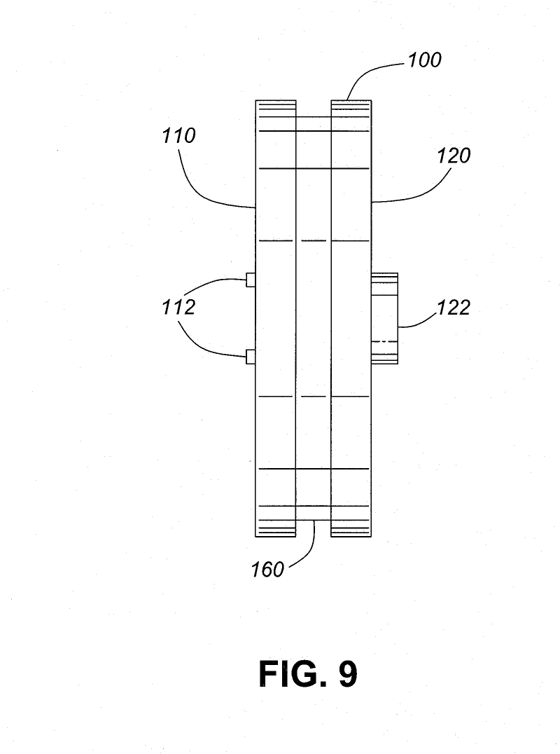

In some embodiments, the main block is solid. In some embodiments, the main block is machined metal, such as but not limited to stainless steel and aluminum. In some embodiments, the spacer is molded. In some embodiments, components of the spacer are molded. In some embodiments, the spacer is one piece. In some embodiments, components of the spacer are welded together. In some embodiments, the spacer has evenly spaced holes in one or both sides in order to reduce weight. In some embodiments, the holes extend thought the main body from the first side to the second side. An example embodiment showing four evenly spaced holes 150 on the second side 120 is shown in FIG. 8. Another method of reducing weight that is used in some embodiments is to include a channel 160 around the circumference of the main body parallel to the bore as shown in FIG. 9. In an example embodiment, the channel has a depth of 0.250″. However, various depths and widths of the channel 160 are possible.

In one example embodiment, the spacer comprises 1045 steel. Other materials can be use, such as but not limited to mild steel and aluminum. Factors to consider when selecting a material are whether the material be strong enough to withstand the torque that will be applied to the spacer when the saw is used for cutting rock and whether the spacer will be light enough for the motor on the saw. If torque or weights are issues, the spacer can be made of aluminum with a steel sleeve pressed into the center.

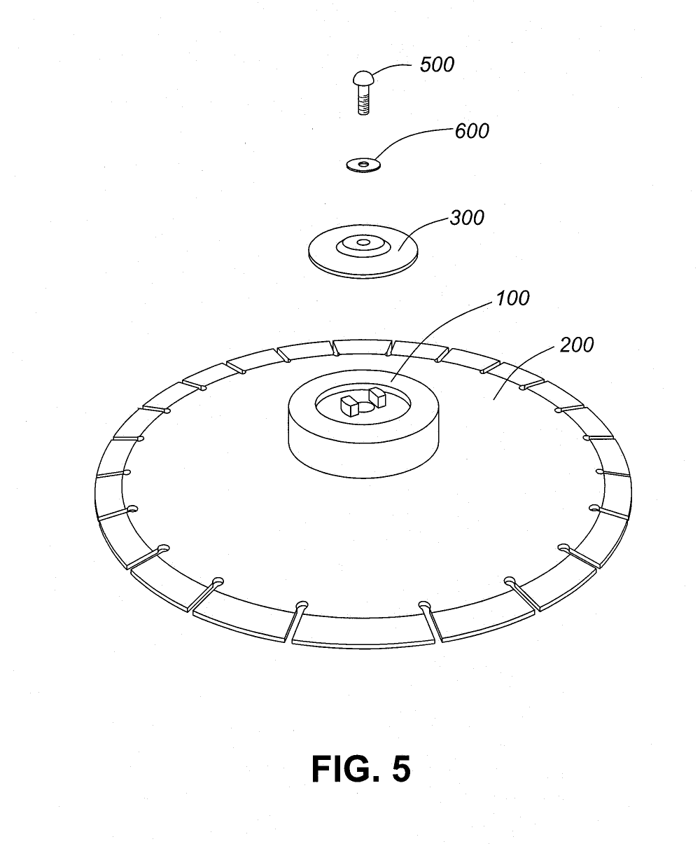

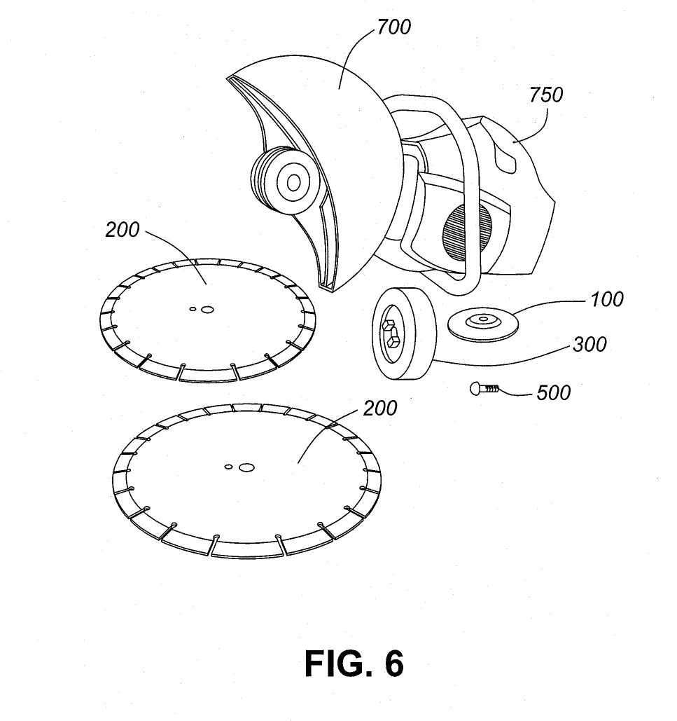

Referring now to FIG. 5, a spacer assembly kit will be described. The kit comprises the spacer 100 described above, a bolt 500 of a length longer than a width of the spacer between the two parallel sides, the width of the first rotary blade, the width of the second rotary blade, a cone shaped washer and a nut for holding the bolt in place. FIGS. 5 and 6 show the components of an example embodiment of the kit together with components from a disassembled saw, i.e, a cone shaped washer 300, the first saw blade 200, and a flat washer 600. In some embodiments, the assembly kit also comprises the second saw blade 200. In some embodiments, the kit also includes a guard 700 wide enough to accommodate the two blades when installed. In some embodiments, the guard is designed to direct water from a hose on the saw over the two blades when in use.

In addition to the kit, FIG. 6 shows a saw 750 onto which the kit can be attached. To assemble a two bladed saw, one of the blades 200 is placed onto the drive shaft. Then the first protrusion 112 of the spacer 100 is inserted into the center hole of the drive shaft. Next, the second blade 200 in placed over the second protrusion 122, and the cone shaped washer 300 is aligned with the center hole of the second blade, the small flat washer 600 is placed on the cone shaped washer aligned with the center hole and then the bolt 500 is inserted through the center holes of the washer, the blades and the bore 130 in the spacer.

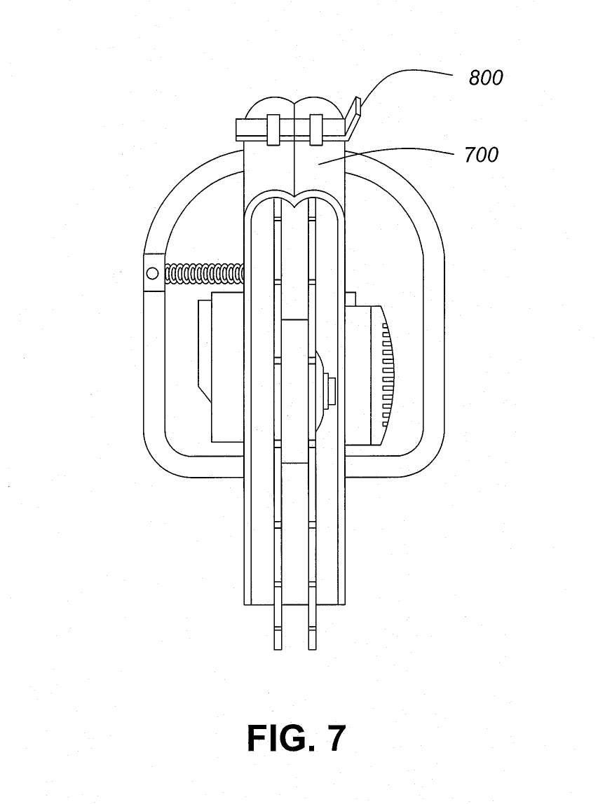

Referring to FIG. 7, a saw 800 modified using the spacer 100 described herein is shown. The modified saw 800 comprises: a motor; a drive shaft; two rotary blades; the spacer assembly kit described above. In some embodiments, such as that shown in FIG. 7, there is a splash guard 700 covering an upper portion of the rotary blades. In some embodiments, the splash guard has a portion that extends between the two rotary blades.

In another aspect, there is provided a method of modifying a handheld rotary blade saw, the method comprising: replacing a guard of the saw with a guard sufficiently wide to allow for two rotary blades; and installing the kit in accordance with the method described above. In some embodiments the flow of water from the saw is modified to be directed over the two blades.

Although the present application discloses example methods and apparatus including other components, such methods and apparatus are merely illustrative and should not be considered as limiting. Accordingly, while example methods and apparatus are described herein, persons having ordinary skill in the art will appreciate that the examples provided are not the only ways to implement such methods and apparatus.

1. A spacer for attaching a first rotary blade and a second rotary blade to a rotary blade saw, the spacer comprising:
a main block having a first side and a second side, the first side and the second side being parallel and the main block having with a bore through the center of the block in a direction perpendicular to the first side and the second side, the bore being a center point of the first side and the second side; and
a first protrusion extending from around the bore on the first side, perpendicular to the first side, the protrusion sized to fit into a center hole on a the first rotary blade; and
a second protrusion extending from around the bore on the second side, perpendicular to the second side, the second protrusion sized to fit into a center hole on the second rotary blade,
the main block further comprising a recessed portion around the bore on each of the parallel sides, the recessed portion being of the same shape as the parallel sides, and the protrusions being in the recessed portion.

2. The spacer of claim 1, wherein the main block is cylindrical in shape.

3. The spacer of claim 1 or 2, wherein the first protrusion is circular in shape.

4. The spacer of any one of claims 1 to 3, wherein at the second protrusion comprises two arced prongs on opposite sides of the bore.

5. The spacer of any one of claims 1 to 4, wherein the first protrusion has a length sufficient to extend through the first rotary blade when the first rotary blade is flush with the first side.

6. The spacer of any one of claims 1 to 5, wherein the second protrusion has a length sufficient to extend through the second rotary blade and a washer.

7. The spacer of any one of claims 1 to 6, wherein the main block is solid.

8. The spacer of any one of claims 1 to 7, wherein the main block has at least two evenly spaced holes in at least one of the first side and the second side.

9. The spacer of any one of claims 1 to 7, wherein the main block has at least two evenly spaced holes that extend from the first side to the second side.

10. The spacer of any one of claims 1 to 7, further comprising a channel around the circumference of the main body parallel with the bore.

11. The spacer of any one of claims 1 to 10, wherein the spacer comprises 1045 steel.

12. The spacer of any one of claims 1 to 10, wherein the spacer comprises aluminum.

13. A spacer assembly kit comprising:
the spacer of any one of claims 1 to 12;
a bolt of a length longer than a width of the spacer between the two parallel sides, the width of the first rotary blade, the width of the second rotary blade, a cone shaped washer and a flat washer.

14. The spacer assembly kit of claim 13, further comprising the second rotary blade.

15. The spacer assembly kit of claim 12 or 13, further comprising a blade guard wide enough to accommodate the first blade and the second blade and the spacer when installed.

16. A saw comprising:
a motor;
a drive shaft;
two rotary blades;
the spacer assembly kit according to claim 13.
